(19) United States
(12) Patent Application Publication
(10) Pub. No.: US 2020/0104247 A1
(43) Pub. Date: Apr. 2, 2020

(54) METHOD AND SYSTEM FOR UNINTERRUPTED AUTOMATED TESTING OF END-USER APPLICATION

(71) Applicant: WIPRO LIMITED, BANGALORE (IN)

(72) Inventors: Girish RAGHAVAN, Rajakeelpakkam (IN); Thamilchelvi PETERBARNABAS, Madipakkam (IN); Shaik ASHA, Perumbakkam (IN)

(21) Appl. No.: 16/195,952

(22) Filed: Nov. 20, 2018

(30) Foreign Application Priority Data
Sep. 29, 2018 (IN) 201841036900

(51) Int. Cl. G06F 11/36; G06F 17/27

(52) U.S. Cl. CPC G06F 11/3688; G06F 17/2785; G06F 11/3684

(57) ABSTRACT

The present disclosure discloses method and system for uninterrupted automation testing of end-user application. The automated testing system receives information about test automation tool, test scenarios of the end-user application and screen flow for each of the test scenarios, from the user. The system then identifies objects, control objects for each of the screens present in each of the test scenarios by using NLP. The objects, control objects, automated steps and corresponding test data are stored in the database. During real time, pre-stored automation steps are executed, and modified screens are identified from failed execution logs. The system then identifies modified objects and control objects in the modified screen and updates object properties. The system also maps the modified control objects to corresponding next screen using NLP. The automation steps are updated for the modified objects, control objects and the test data based on the updated automation steps.

### TECHNICAL FIELD

The present subject matter is related in general to the field of software testing, more particularly, but not exclusively to method and system for uninterrupted automated testing of an end-user application.

### BACKGROUND

Software testing is an investigation conducted to provide stakeholders with information about the quality of the software product or service under test. In software testing, test automation is the use of special software (separate from the software being tested) to control the execution of tests and the comparison of actual outcomes with predicted outcomes. Test automation can automate some repetitive but necessary tasks in a formalized testing process already in place or perform additional testing that would be difficult to do manually. Test automation is critical for continuous delivery and continuous testing.

In the Information Technology eco system, where rapid development and deployment by adapting agile approach is gaining traction, applications that are developed and deployed undergo multiple changes at a very high frequency. With the focus on rapid deployment of these applications, quick unattended validation of the application in a CI/CD (Continuous Integration and Continuous Deployment) is required. However, this requires identifying the object level changes in the application and executing the unattended application validation scripts successfully. Currently, capturing objects in the application and continuous handling of changes is an activity that is carried out separately. Also, the changes in the objects which have been captured needs constant updating. Currently, the changes are being updated manually to ensure that validation scripts are executed, which impacts and increases time required for testing of the applications using test automation tools. This in turn increases the time required for deployment of the application. The increase in the time for deployment in turn leads to increased costs and human resource.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure may relate to a method of performing uninterrupted automated testing of an end-user application. The method comprises retrieving automation steps and test data, for one or more test scenarios of a plurality of test scenarios, by an automated testing system, from a database associated with the automated testing system. The method comprises identifying one or more modified screens from a plurality of screens for each test scenario of an end-user application by executing the automation steps using the test data. For each of the one or more modified screens, the method determines a modification in one or more control objects in the one or more modified screens, identifying next screen for the one or more modified screens based on process flow of the end-user application and mapping the one or more modified control objects to corresponding next screen for the one or more modified screens using Natural Language Processing (NLP).

In an embodiment, the present disclosure may relate to an automated testing system for uninterrupted automated testing of an end-user application. The automated testing system may comprise a processor and a memory communicatively coupled to the processor, where the memory stores processor executable instructions, which, on execution, may cause the system to retrieve automation steps and test data for one or more test scenarios of a plurality of test scenarios, from a database associated with the automated testing system. The system may also identify one or more modified screens from a plurality of screens for each test scenario of an end-user application by executing the automation steps using the test data. For each of the one or more modified screens, the system, determines, a modification in the one or more control objects in the one or more modified screens. The system also identifies, next screen for the one or more modified screens based on process flow of the end-user application and maps, the one or more modified control objects to corresponding next screen for the one or more modified screens using Natural Language Processing (NLP).

Further, the present disclosure includes a non-transitory computer readable medium including instructions stored thereon that when processed by at least one processor causes an automated testing system to perform operations comprising retrieving automation steps and test data for one or more test scenarios of a plurality of test scenarios, from a database associated with the automated testing system. Furthermore, the instructions cause the processor to identify one or more modified screens from a plurality of screens for each test scenario of an end-user application by executing the automation steps using the test data. Upon identifying the one or more modified screens, the instructions cause the processor to perform for each of the one or more modified screens, determining a modification in one or more control objects in the one or more modified screens, identifying next screen for the one or more modified screens based on process flow of the end-user application and mapping the one or more modified control objects to corresponding next screen for the one or more modified screens using Natural Language Processing (NLP).

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment for performing uninterrupted automated testing of an end user application;

FIG. 2 shows a detailed block diagram of an automated testing system in accordance with some embodiments of the present disclosure;

FIG. 3 shows an exemplary flowchart for a method of generating and storing automation steps and test data in a database in accordance with some embodiments of present disclosure;

FIG. 4 illustrates a flowchart for a method of performing uninterrupted automated testing of an end user application in accordance with some embodiments of the present disclosure;

FIG. 5 illustrates a flowchart for a method of storing updated automation steps and updated test data in the database in accordance with some embodiments of the present disclosure;

FIG. 6 shows an exemplary flowchart for a method of obtaining test data from the test data management system in accordance with some embodiments of the present disclosure;

FIG. 7 shows an exemplary illustration of a process flow in an end-user application in accordance with some embodiments of the present disclosure; and

FIG. 8 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Automated testing is a method in software testing which makes use of software tools to control execution of test scripts. The testing may be done automatically with little or no intervention from the user. The present disclosure relates to a method for uninterrupted automated testing of an end-user application. In an embodiment, information about test automation tool, test scenarios and screen flow for each of the test scenarios in the end-user application are received from the user. Initially, automation steps and test data for each of the test scenarios are stored in the database. When there is a modification in the application, the automation steps may be executed along with the test data to identify modified screens, plurality of objects and modified control objects in the screen flow for each of the test scenarios. The modified control objects are mapped to the corresponding next screens in the screen flow by using Natural Language Processing (NLP). The automation steps are then updated according to the modified screens for each of the test scenarios. Also, the test data corresponding to the updated automated steps for the modified screens are obtained from the test data management system using NLP. The modifications such as updating object properties of the plurality of objects present in the modified screens, updating automated steps and the test data corresponding to the updated automated steps are saved in the database. The automated testing system then proceeds to next screen for each of the test scenarios. There is no manual intervention during the execution of automation steps and recognition of modified screens during the testing process. Thus, the automated testing system saves time and cost by making testing more efficient. Also, the automated testing system has wide test coverage because of multiple testing tools which can be deployed for testing of different test scenarios.

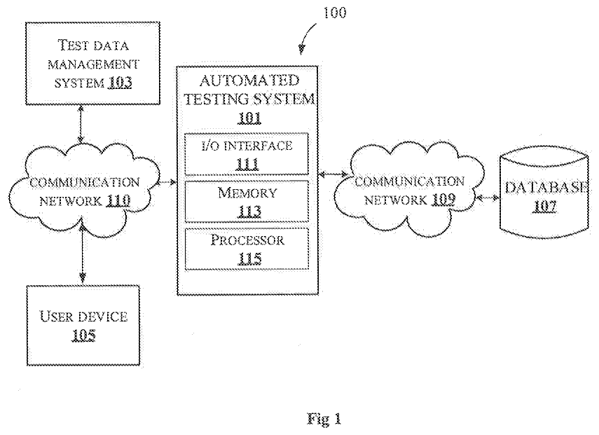

FIG. 1 illustrates an exemplary environment for performing uninterrupted automated testing of an end user application in accordance with some embodiments of the present disclosure.

As shown in FIG. 1, the environment 100 comprises an automated testing system 101, connected through a communication network 109 to a database 107. Further, the automated testing system 101 is also connected through a communication network 110 to a test data management system 103 and to a user device 105. The communication network 109, 110 may include, but is not limited to, a direct interconnection, an e-commerce network, a Peer to Peer (P2P) network, Local Area Network (LAN), Wide Area Network (WAN), wireless network (e.g., using Wireless Application Protocol), Internet, Wi-Fi and the like. End-user application may refer to computer systems and platforms that are meant to allow non-programmers to create working computer applications. It is a compilation of approaches meant to better involve and integrate end users and other non-programmers into computing systems development. The present disclosure may be used for capturing plurality of objects in a screen for testing purpose without manual intervention, thereby automating some of the manual testing tasks during the testing phase of the end user application so as to reduce costs and save time.

The automated testing system 101 may receive information about test automation tool, test scenarios of end-user application and screen flow for each of the test scenarios, from user through an Input/Output (I/O) interface 111. The functionality to be tested as test scenarios may be provided by the user. The screen flow to be navigated for each of the test scenarios may also be defined by the user. The screen flow may comprise plurality of screens, for each of the test scenarios.

The test scenarios and the respective screen flows of the end-user application are stored in the database 107. Based on the selected test automation tool, a plurality of objects along with predefined object properties corresponding to the each of the plurality of screens are obtained through the I/O interface 111 of the automated testing system 101. The predefined object properties may relate to the type of object present in the each of the plurality of screens. Additional objects and the properties of the selected objects may be added or modified by the user through the I/O interface 111. In an embodiment, one or more control objects along with predefined properties of the one or more control objects, from the plurality of objects, may be selected by the automated testing system 101, using Natural Language Processing (NLP). Further, control objects to be captured from the end-user application may also be added or modified by the user. The object types, the associated properties and the control objects for each of the test scenarios are stored in the database 107. The automated testing system 101, may receive test data from the test data management system 103. The test data management system 103 may be internal or external to the automated testing system 101.

The information received from the I/O interface 111 may be stored in the memory 113. The memory 113 may be communicatively coupled to the processor 115 of the automated testing system 101. The memory 113 may also store processor instructions which may cause the processor 115 to execute the instructions for uninterrupted automated testing of an end-user application.

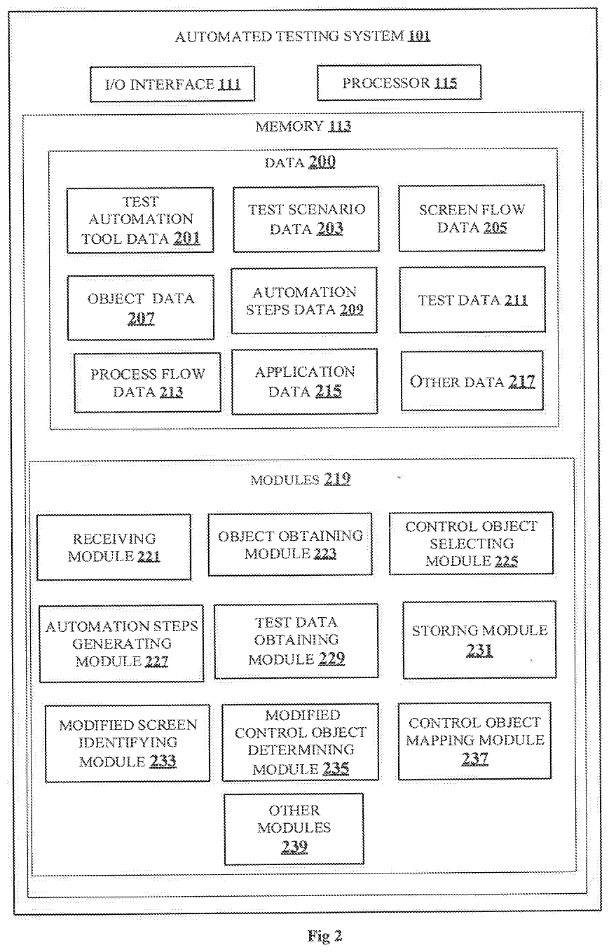

FIG. 2 shows a detailed block diagram of an automated testing system in accordance with some embodiments of the present disclosure.

Data 200 and one or more modules 219 of the automated testing system 101 are described herein in detail. In an embodiment, the data 200 may include test automation tool data 201, test scenario data 203, screen flow data 205, object data 207, automation steps data 209, test data 211, process flow data 213, application data 215 and other data 217.

The test automation tool data 201 may comprise information on type of test automation tool selected by user. For example, the user may select Selenium® or QTP® as the test automation tool based on the type of end-user application.

The test scenario data 203 may comprise the plurality of test scenarios according to the end-user application. A sample test scenario is shown in Table 1.

TABLE 1

| Scenario | Screen1 | Screen2 | Screen3 | Screen4 | Screen5 | Screen6 | Screen7 | Screen8 |
|---|---|---|---|---|---|---|---|---|
| Search | Home | Sign In | Search | Select | Add to | Check | Payment | Log Out |
| and order | Page | | Item | Item | Cart | Out | Details | |
| an item | | | | | | | | |
| Create | Home | Sign Up | User | Payment | Sign In | Log Out | | |
| New | Page | | Address | Methods | | | | |
| User | | | | | | | | |
| Add Gift | Home | Sign In | Add Gift | Log Out | | | | |
| Coupon | Page | | Card | | | | | |
| Details | | | | | | | | |

The screen flow data 205 may comprise the plurality of screens in a sequential order for each of the plurality of corresponding test scenarios as shown in Table 1.

The object data 207 may comprise the plurality of objects and the control objects for each of the plurality of screens corresponding to each of the test scenarios. Objects may contain data, in the form of fields, known as attributes or object properties. For example, an online shopping system may comprise plurality of objects such as “input”, “button”, “link”, “list”, “img”, and “checbox”. The object property may be a numeric value, string value, alphanumeric value etc. according to the type of the plurality of objects. Control object is a type of object which helps in navigating to other screens on performing an operation on the object. In an exemplary embodiment, the operation may be a mouse click or pressing enter button in keyboard. In an exemplary embodiment, the control objects link current screen to next screen or previous screen for each of the plurality of screens corresponding to each of the test scenarios. In an embodiment, Table 2 shows an exemplary sample set of object types, properties and the control objects defined as Yes/No for an end-user application.

TABLE 2

| | Object | Prop- | Prop- | | | | |
|---|---|---|---|---|---|---|---|
| | Type | erty1 | erty2 | Property3 | Property4 | Property5 | Property6 |
| [symbol] | input | id | Name | class | title | | No |
| [symbol] | button | id | Name | class | value | | Yes |
| [symbol] | link | id | Href | title | class | | Yes |
| [symbol] | list | id | Name | class | | | No |
| □ | img | id | Src | title | | | No |
| [symbol] | check | id | Name | class | title | | No |
| | box | | | | | | |

The automation steps data 209 may comprise the automation steps generated for the plurality of objects and the control objects for each of the plurality of screens corresponding to each of the test scenarios. The automation steps may contain methods and procedures to test the validity of the plurality of objects and the control objects present in each of the plurality of screens thereby reducing time taken for testing the entire end user application manually.

The test data 211 may comprise test values obtained for each of the automated steps from the test data management system 103. The test values are data which correspond to each of the plurality of objects and the control objects. The properties of the plurality of objects and the control objects can be validated by the test data. For example, if the end user application has the object field “Name” and “Age”, the test values obtained from the test data management system 103 may be a “string” for the object “Name” and a “numeric value” for the object “age”.

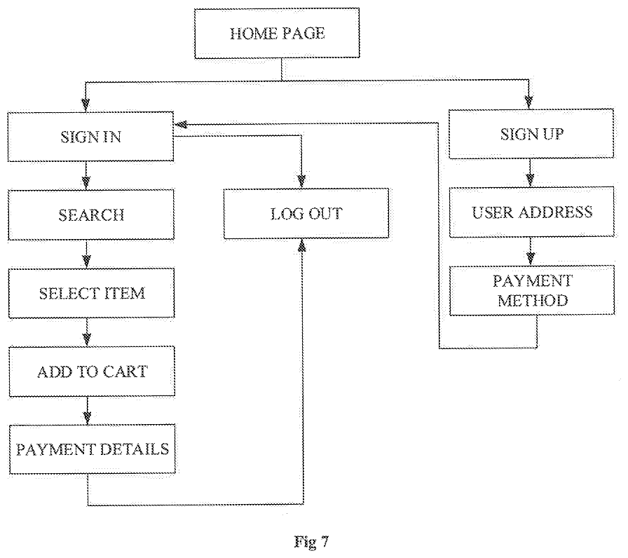

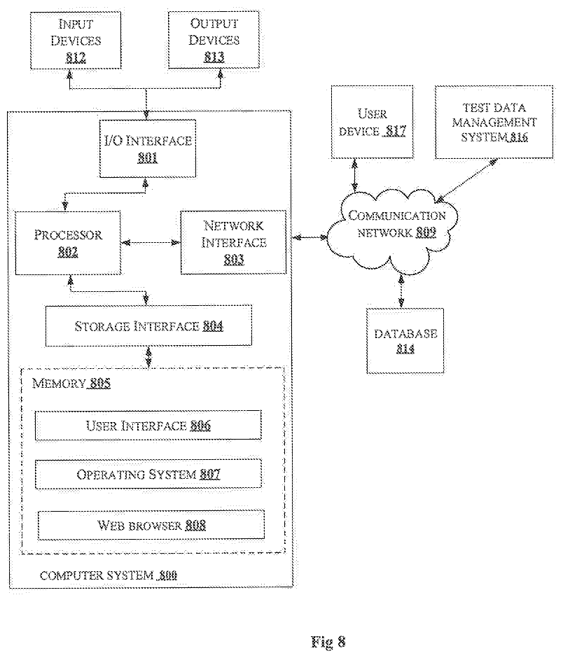

The process flow data 213 may comprise the plurality of screens for each of the test scenarios in form of a tree structure as shown in FIG. 7 below. The tree structure may contain the plurality of screens in logical order and the link between the plurality of screens present in the process flow of the end user application.

The application data 215 may comprise information about type of the end-user application. For example, the information of end-user application may be web, desktop, mainframes, mobile platforms, web services and package application like SAP®, etc. The user may provide the details regarding the type of end-user application.

The other data 217 may store data, including temporary data and temporary files, generated by the modules 219 for performing the various functions of the automated testing system 101.

In an embodiment, the data 200 in the memory 113 are processed by the one or more modules 219 of the automated testing system 101. As used herein, the term module refers to an Application Specific Integrated Circuit (ASIC), an electronic circuit, a field-programmable gate arrays (FPGA), Programmable System-on-Chip (PSoC), a combinational logic circuit, and/or other suitable components that provide the described functionality. The modules 219 when configured with the functionality defined in the present disclosure will result in a novel hardware.

In one implementation, the one or more modules 219 may include, but are not limited to a receiving module 221, an object obtaining module 223, a control object selecting module 225, an automation steps generating module 227, a test data obtaining module 229, a storing module 231, a modified screen identifying module 233, a modified control object determining module 235, and a control object mapping module 237. The one or more modules 219 may also include other modules 239 to perform various miscellaneous functionalities of the automated testing system 101.

The receiving module 221 may receive the request from the user device 105 of the users, for uninterrupted automated testing of the end-user application. The receiving module 221 may receive test data from the test data management system 103. The receiving module 221 may receive stored data from the database 107. The receiving module 221 may also receive information about the test automation tool, the test scenarios and the screen flow for each of the test scenarios in the end-user application from the user.

The object obtaining module 223 may obtain the plurality of objects for each of the plurality of screens corresponding to each of the test scenarios. In an embodiment, the plurality of objects may be selected by the user. In an embodiment, the object obtaining module 223 may obtain the plurality of objects depending on the test automation tool selected by the user.

The control object selecting module 225 may select the control objects from the obtained plurality of objects using NLP techniques. The control objects may also be selected by the user. The control objects link current screen to next screen for each of the plurality of screens corresponding to each of the test scenarios in the tree structure.

The automation steps generating module 227 may generate the automation steps for each of the plurality of screens in each of the test scenarios corresponding to the test automation tool selected by the user. For example: if the present screen contains “User Name, Password and Login button”, the automation steps generated is as shown below.

a. driver.findElement(“//input[@id=‘User Name’”).type username

b. driver.findElement(“//input[@id=‘Password’”).type password

c. driver.findElement(“//button[@id=‘Submit’”).click

After the plurality of objects and the control objects in a screen are captured, and automated steps are generated, data may be associated with the automated steps in the screen to enable automatic navigation to the subsequent screen as per the process flow.

The test data obtaining module 229 may obtain the test data from the test data management system 103. Object names of the plurality of objects and the control objects are obtained from current screen. The test data obtaining module 229 then determines whether data values corresponding to the object names are present in the test data management system 103 using NLP. If the data values are present, the test data obtaining module 229 may obtain test data from the test data management system 103. If the data values are not present, the data values are auto generated by using a data synthesizer. The obtained test data corresponds to the automated steps generated for each of the plurality of screens in each of the test scenarios from the automation steps generating module 227.

The storing module 231 may store the generated automation steps, the test data for the generated automation steps, the updated test data and the updated automation steps for each of the plurality of screens in each of the test scenarios in the database 107. The storing module may also store the object properties of both the plurality of objects and the control objects in the database 107.

The modified screen identifying module 233 may execute the saved automation steps with the previously associated test data. The execution may pause when the modified screen is encountered. The modified screen identifying module 233 retrieves the log of execution of automation steps of the plurality of test scenarios and identifies one or more modified screens of the plurality of screens having object identification related failure based on the log. In an embodiment, the user may also provide the screens which are modified for the end-user application through the I/O Interface 111 to the modified screen identifying module 233.

The modified control object determining module 235 may identify one or more modified objects by comparing the one or more objects present in the one or more modified screens with the stored objects in the database 107. The modified control object determining module 235 may then determine the one or more modified control objects from the plurality of modified objects present in the one or more modified screens by checking whether the control objects are modified.

The control object mapping module 237 may identify the next screen for each of the one or more modified control objects based on the process flow of the end-user application. The control object mapping module 237 may then map the one or more modified control objects in the current screen to the corresponding next screen using NLP.

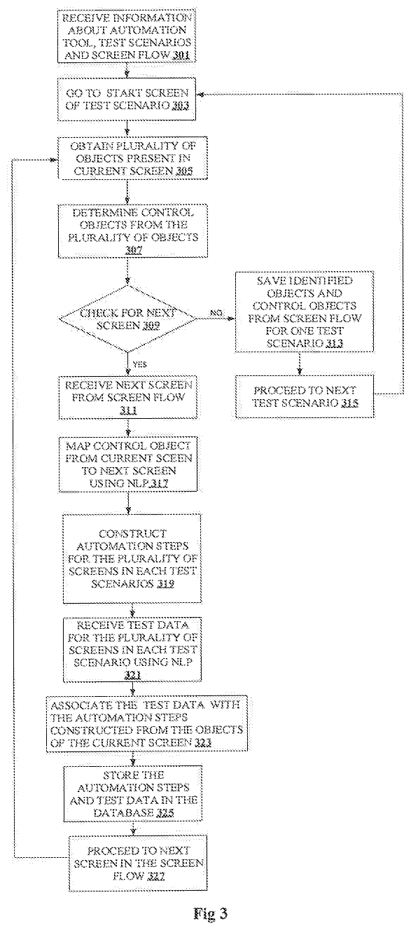

FIG. 3 shows an exemplary flowchart for a method of generating and storing automation steps and test data in the database in accordance with some embodiments of present disclosure.

At block 301, information about the automation tool, the test scenarios and the screen flows are received from the user by the receiving module 221.

At block 303, the object obtaining module 223 may start from the start screen of the plurality of screens of the test scenario. The start screen is the screen which has no incoming links to any other screen.

At block 305, the object obtaining module 223 may obtain the plurality of objects present in the start screen. The start screen is the current screen at the beginning of the screen flow. The current screen is the screen from which the plurality of objects is to be obtained by the object obtaining module. The current screen varies according to the screen flow.

At block 307, the control object selecting module 225 may determine one or more control objects from the plurality of objects. The control objects are objects that link objects from the current screen to next screen.

At block 309, the control object selecting module 225 may check whether the control object is linked to the next screen. If there is a link, block 311 is executed, else the method proceeds to block 313.

At block 313, the plurality of objects and the control objects of the plurality of screens from the screen flow for a test scenario along with corresponding object properties are stored in the database 107 by the storing module 231.

At block 315, the method may proceed to next test scenario. The method proceeds to block 303 where the object obtaining module 223 may again start from the start screen for next test scenario.

At block 311, the information of next screen may be obtained from the screen flow data 205.

At block 317, the control object mapping module 237, may map the control object from the current screen to the next screen using NLP.

At block 319, the automation steps generating module 227 may construct automation steps for the plurality of screens in each of the test scenarios.

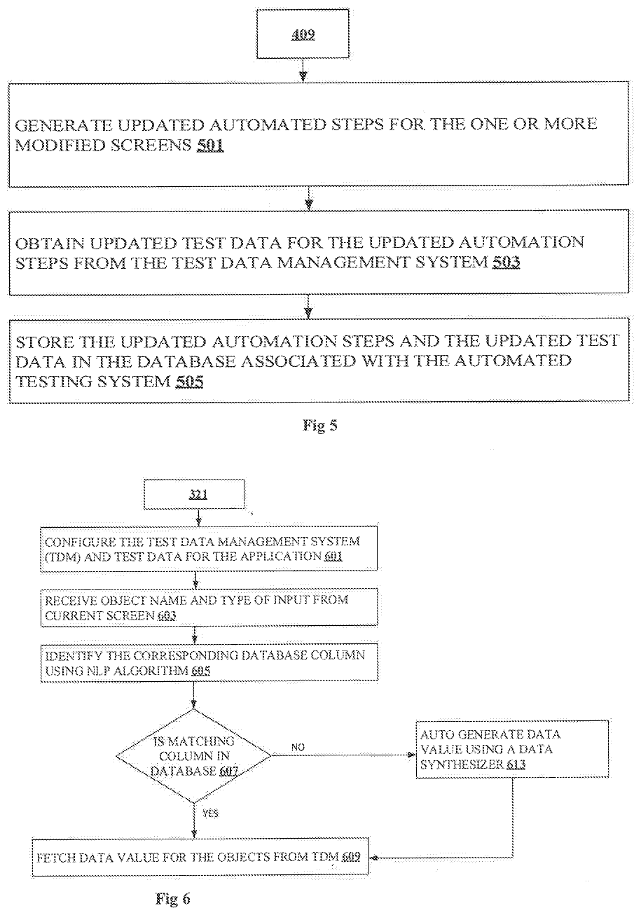

At block 321, the test data 211 from the test data management system 103 may be received for the plurality of screens in each of the test scenarios objects using NLP. The detailed method for obtaining test data from the test data management system 103 is described in FIG. 6 below.

At block 323, the method may associate the test data 211 fetched from the test data management system 103 with the automation steps data 209 constructed from the plurality of objects of the current screen.

At block 325, the storing module 231 may store the automation steps data 209 and test data 211 for the plurality of screens in each of the test scenarios and the corresponding control objects and the plurality of objects present in each screen of the plurality of screens present in the screen flow data 205 in the database 107.

At block 327, the method may proceed to the next screen in the screen flow. Then the block 305 may be executed.

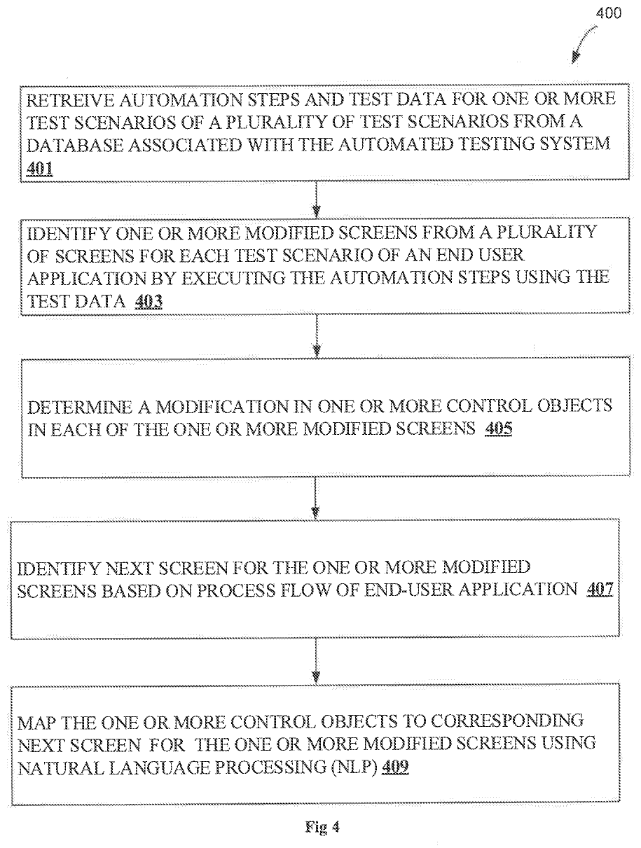

FIG. 4 illustrates a flowchart showing a method of performing uninterrupted automated testing of an end user application in accordance with some embodiments of the present disclosure.

As illustrated in FIG. 4 the method 400 includes one or more blocks uninterrupted automated testing of an end-user application. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 401, the automation steps data 209 and test data 211 for one or more test scenarios of a plurality of test scenarios may be retrieved from a database associated with the automated testing system 101.

At block 403, the one or more modified screens may be identified from the plurality of screens for each test scenario of the end-user application by executing the automation steps data 209 using the test data 211.

At block 405, the modified screen identifying module 233 may execute the automation steps data 209 and may determine the modified screens by identifying the plurality of screens having object identification related failure based on the log of automation steps data 209 retrieved from the database 107. The object obtaining module 223 may determine the plurality of objects present in the modified screen. The modified control object determining module 235 may then determine the modified control objects present in each of the one or more modified screens.

At block 407, the next screen for each of the one or more modified screens connected by the modified control object determining module 235 may be identified based on the process flow data 213 of the end-user application.

At block 409, for each of the one or more modified screens, the control object mapping module 237 may map the modified control objects to the corresponding next screen using NLP.

FIG. 5 illustrates a flowchart for a method of storing the updated automation steps and the updated test data in the database 107.

At block 501, for each of the plurality of screens in each of the test scenarios and the corresponding plurality of modified objects and modified control objects of the modified screens obtained from block 409, updated automation steps may be generated by the automation steps generating module 227.

At block 503, test data 211 for the updated automation steps may be obtained from the test data management system 103. The test data so obtained may be referred to as updated test data.

At block 505, the updated automation steps and the updated test data are stored in the database 107 of the automated testing system 101.

FIG. 6 shows an exemplary flowchart for a method of obtaining test data from the test data management system 103.

At block 601, the test data management system 103 may be configured with the end-user application.

At block 603, the receiving module 221 may receive object name and type of input from the current screen.

At block 605, the test data obtaining module 229 may identify matching columns in the database of the test data management system 103 corresponding to the object name by using NLP algorithm.

At block 607, the test data obtaining module 229 may check whether a matching column in the database of the test data management system 103 is found. If there is a match, the block 609 is executed. Else, block 613 is executed.

At block 609, the test data obtaining module 229 may obtain data values for the one or more of the plurality of objects from the test data management system 103. The block 323 in FIG. 3 is then executed.

At block 613, for each of the plurality of objects for which the matching columns are not found in the database of the test data management system 103, the test data obtaining module 229 may auto-generate the data values using a data synthesizer. The data synthesizer generates contextual and domain specific data for execution of automation scripts. The block 323 in FIG. 3 is then executed.

FIG. 7 shows an exemplary illustration of the process flow in an end-user application like an ecommerce website.

From the home page, the user may either sign up if he is a new user or he may sign in if he is an existing customer of the website. The process flow in the user application varies accordingly. If the user is new, personal information, address and payment method are the subsequent screens in the process flow. If the user is an existing customer, the process flow comprises signing in, searching for item, select an item, then add it to cart, proceed to payment and then log out. The process flow data comprises the details of all the screens for each of the test scenarios.

In an exemplary embodiment, each of the plurality of screens may comprise plurality of objects. For example, in an ecommerce website, the home page screen may comprise text box for user name, password, display boxes for displaying the available items and a login button. Control objects are objects which help in navigating to subsequent screens on performing a click operation on the object. Not every object is a control object. In this case, the Sign In button present in the home page screen takes the user to the subsequent screen which is the search screen as shown in FIG. 7. The Sign In button is a control object. Suppose if the user wants to add second level user authentication such that whenever the Sign In button is pressed, the user may add a new screen in which a One Time Password (OTP) is sent to the user and the user must enter the OTP in the text box present in the new screen. The OTP which is entered by the user is validated and when there is a match, the user is signed in to the ecommerce website. In this case, the control object which takes the navigation to search screen is modified and the OTP authentication is added as new objects. In the current disclosure, the automated testing system 101 retrieves automation steps and test data for one or more test scenarios. The automated testing system 101 then identifies the home page screen which has been modified, by executing the automation steps using the test data. The automated testing system 101 then determines the modification done in the control object (ie the login button) of the home page screen and then maps the modified control object to the new screen which has been created for OTP verification. The automated testing system 101 then maps the control object present in the OTP verification screen to the subsequent screen which is the search screen. The mapping of control object to the corresponding next screen is done by using Natural Language Processing (NLP). The automation steps are then updated according to the modified screens for each of the test scenarios. Also, the test data corresponding to the updated automated steps is obtained by the automated testing system 101 from the test data management system 103 and stored in the database 107. Thus, there is no manual intervention during the testing process.

Computing System

FIG. 8 illustrates a block diagram of an exemplary computer system 800 for implementing embodiments consistent with the present disclosure. In an embodiment, the computer system 800 may be used to implement the automated testing system 101. The computer system 800 may include a central processing unit (“CPU” or “processor”) 802. The processor 802 may include at least one data processor for restoring historic data of an enterprise. The processor 802 may include specialized processing units such as, integrated system (bus) controllers, memory management control units, floating point units, graphics processing units, digital signal processing units, etc.

The processor 802 may be disposed in communication with one or more input/output (I/O) devices (not shown) via I/O interface 801. The I/O interface 801 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 801, the computer system 800 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 800 consists of the automated testing system 101. The processor 802 may be disposed in communication with the communication network 809 via a network interface 803. The network interface 803 may communicate with the communication network 809. The network interface 803 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 809 may include, without limitation, a direct interconnection, local area network (LAN), wide area network (WAN), wireless network (e.g., using Wireless Application Protocol), the Internet, etc. Using the network interface 803 and the communication network 809, the computer system 800 may communicate with a database 814. Further, the computer system 800 may also communicate with a test data management system 816 and a user device 817. The network interface 803 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 809 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 802 may be disposed in communication with a memory 805 (e.g., RAM, ROM, etc. not shown in FIG. 6) via a storage interface 804. The storage interface 804 may connect to memory 805 including, without limitation, memory drives, removable disc drives, etc., employing connection protocols such as, serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 805 may store a collection of program or database components, including, without limitation, user interface 806, an operating system 807 etc. In some embodiments, computer system 800 may store user/application data 806, such as, the data, variables, records, etc., as described in this disclosure. Such databases may be implemented as fault-tolerant, relational, scalable, secure databases such as Oracle or Sybase.

The operating system 807 may facilitate resource management and operation of the computer system 800. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system 800 may implement a web browser 808 stored program component. The web browser 808 may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 608 may utilize facilities such as AJAX™, DHTML™, ADOBE® FLASH™, JAVASCRIPT™, JAVA™, Application Programming Interfaces (APIs), etc. In some embodiments, the computer system 800 may implement a mail server stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 600 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

An embodiment of the present disclosure helps in saving time spent for testing plurality of objects and control objects manually.

An embodiment of the present disclosure reduces cost spent for testing an end-user application thereby improving Return On Investment (ROI) of automation.

An embodiment of the present invention can efficiently handle multiple requirement changes arising spontaneously in an agile environment.

An embodiment of the present disclosure automates repetitive tasks performed by a person manually testing an end-user application.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as, an optical fiber, copper wire, etc. The transmission signals in which the code or logic is encoded may further include a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 3, 4, 5 and 6 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral numerals:

| Reference Number | Description |
|---|---|
| 100 | Environment |
| 101 | Automated testing system |
| 103 | Test data management system |
| 105 | User device |
| 107 | Database |
| 109 | Communication network |
| 110 | Communication network |
| 111 | I/O interface |
| 113 | Memory |
| 115 | Processor |
| 200 | Data |
| 201 | Test automation Tool data |
| 203 | Test scenario data |
| 205 | Screen flow data |
| 207 | Object data |
| 209 | Automation steps data |
| 211 | Test data |
| 213 | Process flow data |
| 215 | Application Data |
| 217 | Other Data |
| 219 | Modules |
| 221 | Receiving module |
| 223 | Object obtaining module |
| 225 | Control object selecting module |
| 227 | Automation steps generating module |
| 229 | Test data obtaining module |
| 231 | Storing module |
| 233 | Modified screen identifying module |
| 235 | Modified control object determining module |
| 237 | Control object mapping module |
| 239 | Other modules |
| 800 | Computer system |
| 801 | I/O interface |
| 802 | Processor |
| 803 | Network interface |
| 804 | Storage interface |
| 805 | Memory |
| 806 | User interface |
| 807 | Operating system |
| 808 | Web browser |
| 809 | Communication network |
| 812 | Input devices |
| 813 | Output devices |
| 814 | Database |
| 816 | Test data management system |
| 817 | User device |

What is claimed is:

1. A method of performing uninterrupted automated testing of an end-user application, the method comprising:
retrieving, by an automated testing system, automation steps and test data for one or more test scenarios of a plurality of test scenarios, from a database associated with the automated testing system;
identifying, by the automated testing system, one or more modified screens from a plurality of screens for each test scenario of an end-user application by executing the automation steps using the test data; and
performing, by the automated testing system, for each of the one or more modified screens:
determining a modification in one or more control objects in the one or more modified screens;
identifying next screen for the one or more modified screens based on process flow of the end-user application; and
mapping the one or more modified control objects to corresponding next screen for the one or more modified screens using Natural Language Processing (NLP).

2. The method as claimed in claim 1, further comprising storing the automation steps and the test data for the one or more test scenarios in the database, which is retrievable by the automated testing system, wherein the storing comprises:
receiving, by the automated testing system, information about test automation tool, test scenarios of the end-user application, and screen flow for each of the test scenarios, from user of the end-user application, wherein the screen flow comprises the plurality of screens, for each of the test scenarios;
obtaining, by the automated testing system, a plurality of objects associated with the end-user application along with predefined properties of the plurality of objects using the test automation tool;
generating, by the automated testing system, the automation steps for the plurality of screens in each of the test scenarios;
obtaining, by the automated testing system, the test data for the plurality of objects of the plurality of screens from a test data management system using Natural Language Processing (NLP); and
storing, by the automated testing system, the automation steps and the test data in the database associated with the automated testing system.

3. The method as claimed in claim 2, further comprises:
selecting, by the automated testing system, the one or more control objects along with predefined properties of the one or more control objects, from the plurality of objects, using Natural Language Processing (NLP); and
storing, by the automated testing system, the one or more control objects along with predefined properties of the one or more control objects in the database.

4. The method as claimed in claim 1, wherein the one or more test scenarios of plurality of test scenarios are identified by:
retrieving, by the automated testing system, log of execution of automation steps of the plurality of test scenarios;
identifying, by the automated testing system, one or more modified screens of the plurality of screens having object identification related failure based on the log; and
determining, by the automated testing system, the one or more test scenarios comprising the one or more modified screens.

5. The method as claimed in claim 1 further comprising:
generating, by the automated testing system, updated automated steps for the one or more modified screens;
obtaining, by the automated testing system, updated test data for the updated automation steps from the test data management system; and
storing, by the automated testing system, the updated automation steps and the updated test data in the database associated with the automated testing system.

6. The method as claimed in claim 2, wherein the test automation tool is selected based on type of the end-user application.

7. The method as claimed in claim 1, wherein the process flow is generated by constructing a tree structure of the plurality of screens of each of the test scenarios.

8. An automated testing system for uninterrupted automated testing of an end-user application, comprising:
a processor; and
a memory communicatively coupled to the processor, wherein the memory stores processor instructions, which, on execution, causes the processor to:
retrieve automation steps and test data for one or more test scenarios of a plurality of test scenarios, from a database associated with the automated testing system;
identify one or more modified screens from a plurality of screens for each test scenario of an end-user application by executing the automation steps using the test data; and
perform for each of the one or more modified screens:
determine a modification in the one or more control objects in the one or more modified screens;
identify next screen for the one or more modified screens based on process flow of the end-user application; and
map the one or more modified control objects to corresponding next screen for the one or more modified screens using Natural Language Processing (NLP).

9. The automated testing system as claimed in claim 8, wherein the processor is further configured to store automation steps and the test data for the one or more test scenarios in the database, which is retrievable by the automated testing system, wherein the storing comprises:
receiving information about test automation tool, test scenarios of the end-user application and screen flow for each of the test scenarios, from user of the end-user application, wherein the screen flow comprises the plurality of screens, for each of the test scenarios;
obtaining a plurality of objects associated with the end-user application along with predefined properties of the plurality of objects using the test automation tool;
generating the automation steps for the plurality of screens in each of the test scenarios;
obtaining the test data for the plurality of objects of the plurality of screens from a test data management system using Natural Language Processing (NLP); and
storing the automation steps and the test data in the database associated with the automated testing system.

10. The automated testing system as claimed in claim 9, wherein the processor is configured to:
select the one or more control objects along with predefined properties of the one or more control objects, from the plurality of objects, using Natural Language Processing (NLP); and
store the one or more control objects along with predefined properties of the one or more control objects in the database.

11. The automated testing system as claimed in claim 8, wherein the processor is configured to identify the one or more test scenarios of plurality of test scenarios by:
retrieving log of execution of automation steps of the plurality of test scenarios;
identifying one or more modified screens of the plurality of screens having object identification related failure based on the log; and
determining the one or more test scenarios comprising the one or more modified screens.

12. The automated testing system as claimed in claim 8, wherein the processor is further configured to:
generate updated automated steps for the one or more modified screens;
obtain updated test data for the updated automation steps from the test data management system; and
store the updated automation steps and the updated test data in the database associated with the automated testing system.

13. The automated testing system as claimed in claim 8, wherein the test automation tool is selected based on type of the end-user application.

14. The automated testing system as claimed in claim 8, wherein the process flow is generated by constructing a tree structure of the plurality of screens of each of the test scenarios.

15. A non-transitory computer readable medium including instructions stored thereon that when processed by at least one processor causes an automated testing system to perform operations comprising:
retrieving automation steps and test data for one or more test scenarios of a plurality of test scenarios, from a database associated with the automated testing system;
identifying one or more modified screens from a plurality of screens for each test scenario of an end-user application by executing the automation steps using the test data; and
performing for each of the one or more modified screens:
determining a modification in one or more control objects in the one or more modified screens;
identifying next screen for the one or more modified screens based on process flow of the end-user application; and
mapping the one or more modified control objects to corresponding next screen for the one or more modified screens using Natural Language Processing (NLP).
